(19) United States
(12) Patent Application Publication
(10) Pub. No.: US 2009/0153529 A1
(43) Pub. Date: Jun. 18, 2009

(54) DISPLAY APPARATUS AND COMMUNICATION SYSTEM FOR DRIVE DATA OF THE SAME APPARATUS

(76) Inventor: Takeo Masuda, Miyazaki (JP)

Correspondence Address: MCDERMOTT WILL & EMERY LLP, 600 13TH STREET, N.W., WASHINGTON, DC, 20005-3096, US

(21) Appl. No.: 11/990,943

(22) PCT Filed: Aug. 25, 2005
(86) PCT No.: PCT/JP2005/051469

§ 371 Date: Oct. 29, 2008

(51) Int. Cl. G09G 5/00

(52) U.S. Cl. 345/204

(57) ABSTRACT

A display apparatus includes a display panel, a communication controller that acquires a piece of drive data related to the display panel from pieces of drive data stored in a server via a network, a storage unit that stores the acquired piece of drive data and history management information for the display panel and the piece of drive data, a display driver that displays images on the display panel according to the piece of drive data stored in the storage unit, and a drive controller that has the communication controller acquire the piece of drive data for the display panel using the history management information and updates a piece of drive data previously stored in the storage unit to the acquired piece of drive data.

### TECHNICAL FIELD

The present invention relates to display apparatuses and communication systems for drive data of the display apparatuses, and in particular, the present invention relates to a display apparatus capable of acquiring data for controlling a display via a communication line to update various drive data required for displaying an image on the display apparatus, as well as a communication system for such drive data.

### BACKGROUND ART

In recent years, various types of display apparatuses such as CRT, LCD, and PDP have been provided.

A typical display apparatus previously stores drive data required for displaying an image on a display panel, reads drive data that is required when displaying an image, and controls a display drive circuit according to the drive data, and thereby displays the image on the display.

For example, in a PDP (plasma display panel), an image is displayed by causing a discharge for each pixel, and a drive control is performed such that various voltages are applied to an address electrode and a display electrode at a predetermined timing.

In order to perform such a drive control, a voltage value to be applied to the electrode and control information relating to the timing of application are previously stored in a storage device such as a ROM.

Such control information is determined at designing a display apparatus and previously stored in a nonvolatile memory such as a ROM, as value information that satisfies the designed display characteristics at shipping as a product, and is not changed normally.

Even after shipping, however, in order to improve the display characteristics of the display panel, the control information is better changed in some cases, and it is necessary to change the control information in other cases.

As described above, when it is necessary to change the control information, conventionally, a person in charge brings a write only device for the control information to the site where the display panel is installed, and changes the control information by connecting the write only device to each display panel one by one.

When there are many display apparatuses in a factory or a storehouse before shipping, the rewriting can be performed repeatedly on the side. However, when the display apparatuses have been already shipped to a retail store or a user, many workers are required to visit various places over the country in order to alter the control information, which can be expensive and time consuming.

Further, a system for remote controlling in the field of such as image monitoring is commonly provided. This system is constructed in order to transmit information for remotely controlling an operation of an information device to the information device, or to monitor the current state of the information device and such (for example, see Japanese Unexamined Patent Application No. 2002-58077).

For a typical display apparatus such as a PDP, control information that can change display characteristics of the apparatus is not usually available to a user for alteration of the control information. Further, the control information does not need to be altered unless a serious problem is found. For these reasons, remote control devices intended for alteration of the characteristics of the display apparatus have not been developed.

However, along with increased complexity of internal hardware of display apparatuses, it is predicted that on-site maintenance can be time consuming and troublesome. Accordingly, an improvement of working efficiency of on-site maintenance and a reduction of operating cost and time that are intended for an improvement of the display characteristics are required.

### DISCLOSURE OF THE INVENTION

The present invention is a display apparatus which has a display panel; a communication controller that acquires a piece of drive data related to the display panel from pieces of drive data stored in a server via a network; a storage unit that stores the acquired piece of drive data and history management information for the display panel and the stored piece of drive data; a display driver that displays an image on the display panel according to the piece of drive data stored in the storage unit; and a drive controller that has the communication controller acquire a piece of drive data for the display panel by using the history management information and updates a piece of drive data previously stored in the storage unit to the acquired piece of drive data.

With such a configuration, it is possible to reduce time for update processing of the drive data, to facilitate the update processing, and to reduce cost for maintenance of the update processing.

Here, the drive data includes following data.

(1) A value of a voltage to be applied to an electrode of a plasma display panel.

(2) A timing at which the voltage is applied to the electrode and a pulse width of the applied voltage.

(3) Data defining an order of a plurality of sub-fields that constitute a single field as a unit of a display period for the plasma display panel.

(4) Data defining a number of gray scale levels for the plasma display panel and a combination of sub-fields corresponding to the number of gray scale levels.

The history management information includes a unique identification number for identifying the display apparatus, and a history number for a piece of drive data that is currently stored in the storage unit, and the communication controller acquires a piece of drive data sent from the server after sending the history management information to the server. In this case, the server uses the received history management information to determine the need of the drive data update, and sends the relating piece of drive data to this display apparatus.

The display apparatus further includes an input unit for instructing a request for updating the piece of drive data to the server. And when the update request is inputted via the input unit, the communication controller sends the update request to the server and then may receive a piece of drive data from the server.

Further, the storage unit may store timing information related to time at which send a request for updating the drive data to the server, and the communication controller may send the update request to the server according to the timing information.

Further, the present invention provides a drive data communication system including: a server; and display apparatuses connected to the server via a network, wherein the server is provided with a database storing a plurality of pieces of drive data respectively for the display apparatuses, and each display apparatus is provided with a display panel, a communication controller that acquires a piece of drive data related to the display panel from the server, a storage unit that stores the piece of drive data and history management information for the display panel and the piece of drive data, a display driver that displays an image on the display panel according to the piece of drive data stored in the storage unit, and a drive controller that updates a piece of drive data previously stored in the storage unit to the piece of drive data acquired by the communication controller.

Moreover, the present invention provides a drive data communication system including: an update control apparatus; and a plurality of display apparatuses connected to the update control apparatus via a network, wherein the update control apparatus is provided with a database storing a plurality of pieces of drive data respectively for the display apparatuses, and a transmission unit that transmits a piece of drive data to a display apparatus that belongs to a specific group, and each display apparatus is provided with a display panel, a communication controller that receives a piece of drive data related to the display panel from the update control apparatus, a storage unit that stores the piece of drive data and history management information specifying the display panel, a display driver that displays an image on the display panel according to the piece of drive data stored in the storage unit, and a drive controller that updates a piece of drive data previously stored in the storage unit to the piece of drive data received by the communication controller after confirming that the received piece of drive data is transmitted from the update control apparatus that is given an update permission.

### BRIEF DESCRIPTION OF THE DRAWINGS

FIG. 1 is a configuration block diagram of a display apparatus and a communication system that updates drive data according to the present invention.

FIG. 2 is a flowchart of update processing of the drive data according to the present invention.

FIG. 3 is a configuration block diagram of the update processing of another embodiment according to the present invention.

### BEST MODE FOR CARRYING OUT THE INVENTION

The following describes an embodiment of the present invention with reference to the drawings. It should be noted that the following description of the embodiment is not intended to limit the present invention.

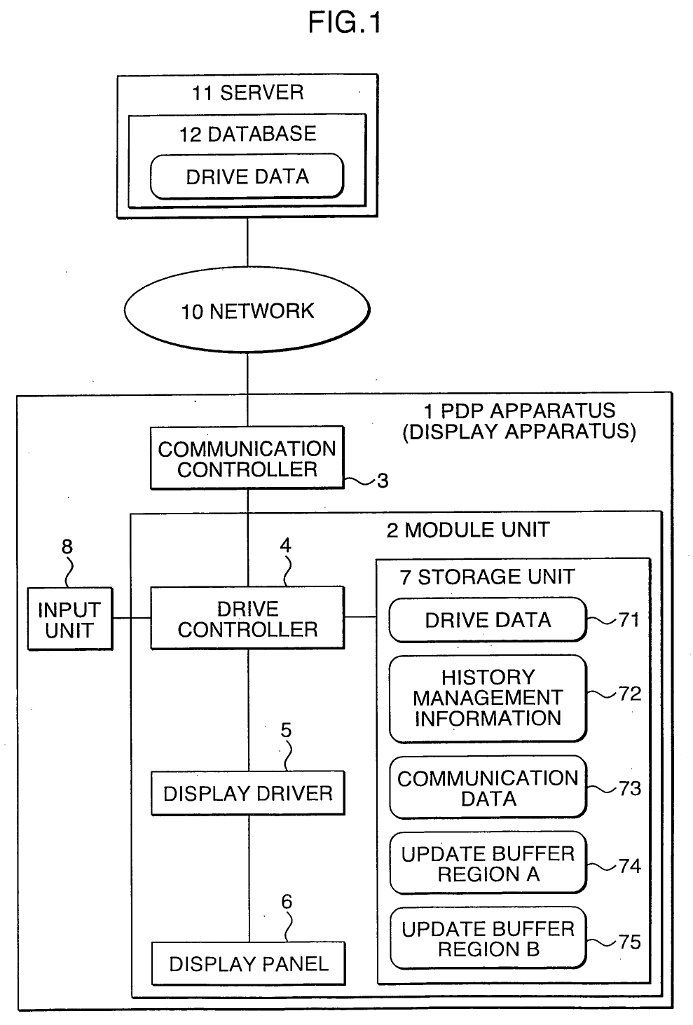

FIG. 1 shows a configuration block diagram of one embodiment of a display apparatus and a drive data communication system according to the present invention.

In the description, a PDP apparatus is shown as one embodiment of a display apparatus 1.

It should be noted that such a display apparatus is not limited to a PDP apparatus, and the present invention can be applied to a CRT apparatus or an LCD apparatus.

As shown in FIG. 1, the display apparatus 1 (hereinafter referred to as a PDP apparatus) is mainly constituted by an input unit 8, a module unit 2, and a communication controller 3.

As the input unit 8, any input device such as a keyboard or a pointing device can be used, and a remote control unit that comes with the PDP apparatus can also be used. Further, the remote control unit can be provided with a key exclusively used for requesting drive data update.

The communication controller 3 connects the PDP apparatus 1 to a server 11 via a network 10, and is provided with such as a function for the Internet access and a function for communicating with the server 11.

The server 11 is an information device, for example, that is installed at a site of a manufacturer of the PDP apparatus 1, a maintenance service provider, or such, and stores information relating to the PDP apparatus in a database 12 of the server 11. The information relating to the PDP apparatus stored in the database 12 includes such as drive data as described later, and a unique number, a serial number, a date of manufacture, and such of a shipped product.

Various communication lines such as ISDN, telephone line, ADSL, and HTTP can be used as the network 10, and it is preferable to provide an access to the Internet via any of the above listed communication lines in an environment allowing a continuous connection and ensuring an adequate level of security.

The module unit 2 is mainly constituted by a drive controller 4, a display driver 5, a storage unit 7, and a display panel 6.

The display panel 6 is a so-called plasma display panel (PDP), configured such that predetermined electrodes are arranged in matrix and pixels are separated by barrier ribs, and configured to cause a plasma discharge on a pixel-by-pixel basis according to a control signal from the display driver 5 to emit light.

The drive controller 4 controls an operation of the communication controller 3, and performs the processing such as write processing for writing information received by the communication controller 3 into the storage unit 7, read processing for reading drive data stored in the storage unit 7, produce processing for producing a drive signal or a drive voltage according to the read drive data, timing control processing for controlling timing at which such as the drive signal is outputted to the display driver, and shutdown processing for turning the power down.

The display driver 5 is a control circuit for actuating the display panel 7 according to various drive signals outputted from the drive controller 4, and configured by functional blocks such as a reset pulse producing unit and a sustain pulse producing unit, for example.

The storage unit 7 is a memory storing control information relating to the PDP apparatus, and a rewritable nonvolatile memory is used as the storage unit 7. For example, an EPROM, a flash memory, a hard disk, and such are used.

Examples of the control information stored in the storage unit 7 include drive data 71 of the PDP apparatus, history management information 72, communication data 73 required for communication control, and such.

Further, the drive data 71 is stored in a storage area in the storage unit 7 (drive data storage area) in initialization before shipping. The drive data 71 is also stored temporarily in an update buffer region A (74) and an update buffer region B (75) that are provided in order to perform the update processing that is described later.

In the later described embodiment, the region A (74) is used to temporarily read and store the drive data 71 that is currently stored, and used in a restoring mode processing in which the drive data is restored.

The region B (75) is a buffer region for temporarily storing drive data when the drive data acquired from the server 11 is downloaded.

The history management information 72 includes, information on the date (day, month, year) of previous writing, a history number (revision, version number), a unique identification number of the PDP apparatus 1, a model number, a date of manufacture, a module version number, and such.

The control information is previously written in the storage unit 7 at a manufacturing stage before shipping. Then, when no design alteration or data update is necessary, display processing of the PDP apparatus is performed using the default data that is previously written.

According to the present invention, the control information relating to the display characteristics of the PDP apparatus is referred to as drive data.

The drive data mainly includes, but not limited to, the following data.

(1) Data for Controlling an Application Voltage (Voltage Data)

The application voltage indicates a reset voltage, a sustain voltage, address voltage, and such.

Further, the data for controlling the application voltage indicates a value of, for example, the reset voltage itself, and the value of the reset voltage may be directly stored.

Alternatively, rather than the value of the reset voltage itself, the data for controlling the application voltage can indicate a parameter relating to a drive circuit for controlling the reset voltage, and the value of the parameter may be stored.

In this case, the read value of the parameter is supplied to the drive circuit that controls the reset voltage, and the drive circuit produces the reset voltage according to the value of the parameter.

(2) Data for Defining an Application Timing (Timing Data)

An application timing represents a time difference or time interval with which the application voltage is applied with respect to a certain reference time.

For example, data indicating a time interval between applications of address voltages in one line and a following line is stored in the storage unit 7 as an application timing.

(3) Data for Defining a Pulse Width of the Application Voltage (Pulse Width Data)

Because the application voltage is usually applied in a pulse waveform, a pulse width corresponds to a time period during which the pulse waveform is being applied.

The pulse width represents, for example, a width of such as a reset pulse, a sustain pulse, a scan pulse, or an address pulse (application period).

(4) Drive Waveform Formation Data

Drive waveform formation data represents data relating to a sequential order of a plurality of sub-fields (SF) constituting a single field, and, for example, represents data with a sequential order in which, when a single field includes 8 sub-fields (SF), a leading SF is SF8, and then a following SF is SF7.

Further, the drive waveform formation data also includes data relating to an order of periods that constitute an SF.

The periods that constitute an SF typically includes three periods: “reset period”, “address period”, and “sustain period”. The data relating to the order of these periods, for example, represents data in which the reset period comes first, then the address period, and finally the sustain period.

In addition, the data for periods that constitute an SF may be different for each SF, and a certain period may not be included in a certain SF.

(5) Display Characteristics Data

Display characteristics data represents data relating to a combination (table) between a number of gray scale levels and a sub-field(s) (SF) to be turned on.

For example, when the number of gray scale levels is “30/256”, and when each SF is allocated with a number as 1, 2, 4, . . . 128 from SF1 in binary code, a number of SF is 8,then the SFs to be turned on are SF2, SF3, SF4, and SF5 (2+4+8+16=30).

The above described is one embodiment of the drive data used in the present invention. Other than this embodiment, parameters defining the display characteristics can be included in the drive data and stored in the storage unit 7.

Such drive data is previously stored in the storage unit 7 before shipping as initial values.

Further, after shipping, the drive data that has been stored in the storage unit 7 is updated by communicating with the server 11 in a state in which the PDP apparatus 1 is actually used and by receiving only up-to-date drive data and necessary drive data from the server 11.

The update can be performed by overwriting the previously stored drive data, also in order to bring back to a state before updating in view of stability of operation, the update can be performed by storing in a buffer as a temporary storage or in a storage area separate from an area storing the initial values.

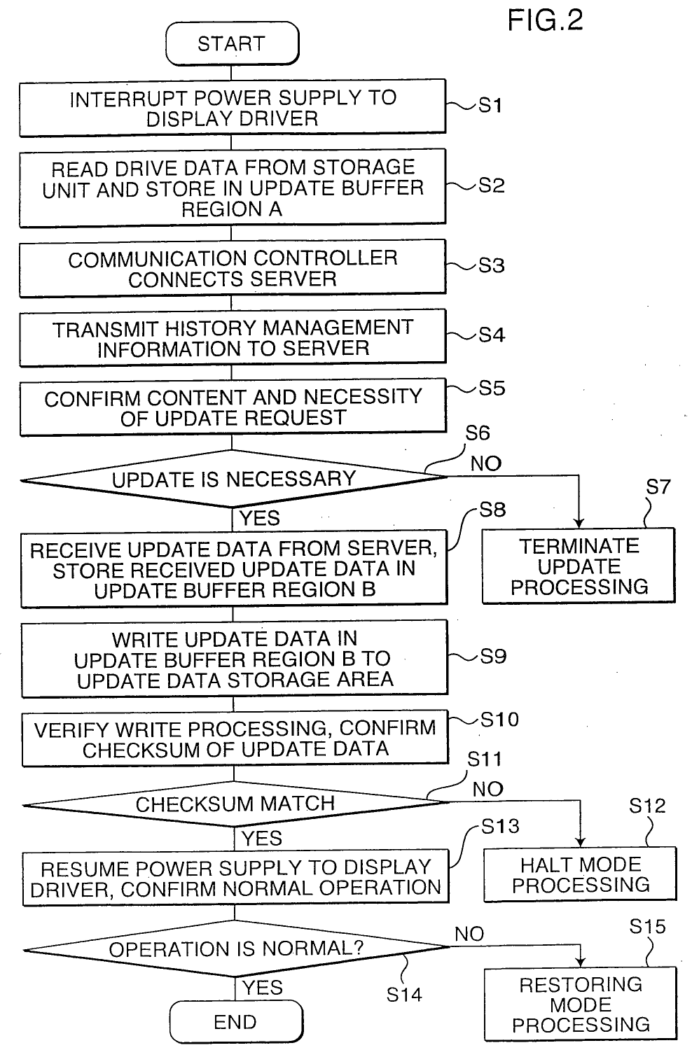

FIG. 2 shows a flowchart of one embodiment of the update processing of the drive data of the PDP apparatus according to the present invention. Here, the update processing is started by an activating operation at the PDP apparatus 1 as a display apparatus.

For example, the update processing is started by an owner who has installed the PDP apparatus 1 making an input through a specific switch (or a specific button of a remote control).

Alternatively, a serviceman can perform an input operation of the specific switch during handling the PDP apparatus 1.

The specific input operation indicating an start of the update processing is executed by the input unit 8, and a signal representing the start of update is supplied to the drive controller 4 from the input unit 8.

Step S1: Stopping the Display Driver 5

First, the drive controller 4 that receives the signal representing the initiation of update stops an operation of the display driver 5 of the module unit 2.

This is done in order to avoid a false operation of the display driver 5 while executing the processing in subsequent steps after Step 2.

Here, the operation is stopped, for example, by interrupting power supply to the display driver 5.

Step S2: Reading the Drive Data

The drive controller 4 reads the drive data that is currently stored in the storage unit 7, and stores the read drive data in the update buffer region A (74) in the storage unit 7.

At this time, the current history management information 72 is also read and stored in the buffer region A.

Step S3: Connecting to the Server

The drive controller 4 sends a request for connection to the server 11 to the communication controller 4.

At this time, the communication data 73 that is necessary for connecting to the server and previously stored in the storage unit 7 is read and provided to the communication controller 3 along with the history management information 72.

The communication controller 3 executes connection processing to the server 11 according to the supplied information.

Step S4: Sending update request information to the server After establishing the connection, the communication controller 3 sends information representing a request of updating the drive data to the server 11.

The update request information includes information used for specifying each PDP apparatus 1 (such as a unique identification number and a model number), as well as information used for specifying the current drive data (such as a history number).

Step S5: Confirming the Update Request (Server Side)

Receiving the update request, the server 11 confirms the information included in the update request and determines whether or not there is a piece of drive data that should be updated.

The database 12 in the server 11 stores each piece of drive data attached with a history number for each model of the PDP or for each module version number.

For example, the server 11 checks if there is a piece of drive data corresponding to the model number included in the received update request is stored in the database 12. Further, when there is the piece of drive data, the server 11 verifies whether or not the received history number is identical with the history number in the stored drive data, or older. That is, the server 11 confirms whether or not the update is necessary.

Step S6: Determining Necessity of Update (Server Side)

As a result of confirmation in Step S5, for example, when a piece of drive data that corresponds to the PDP apparatus 1 is not present, or when the history numbers are identical even if the piece of drive data is present, the server 11 determines that the update is unnecessary, and the operation advances to Step S7 (update completion processing).

On the other hand, when there is a piece of drive data that corresponds to the PDP apparatus and the received history number is older than a newest history number that is currently stored in the server, then the server 11 determines that the update is necessary, and the operation advances to Step S8.

Step S7: Update Completion Processing

Here, a notification is transmitted from the server 11 to the communication controller 3 that the update is unnecessary.

The communication controller 3 receiving this notification sends information, to the drive controller 4, indicating the update processing should be terminated, and terminates the update processing.

Step S8: Transmitting the Drive Data (Download)

When a piece of drive data that should be updated is present in the server 11, the piece of drive data is transmitted from the server 11 to the communication controller 3. Specifically, the communication controller 3 downloads the piece of drive data.

The drive controller 4 temporarily stores the piece of drive data received by the communication controller 3 in the update buffer region B (75) in the storage unit 7.

Here, the piece of drive data is temporarily stored in the region B (75) separate from the region A, rather than overwriting in the update buffer region A (74), so that it is possible to bring back to a state before updating even if an inconvenience occurs in an operation according to the newly received piece of drive data.

Step S9: Write Processing of the Drive Data

After storing the received piece of drive data in the update buffer region B (75), the stored piece of drive data is written to a drive data storage area 71 in the storage unit 7. With this, the drive data has been updated if there is no inconvenience.

Step S10: Verifying the write processing (verification)

Whether or not the write processing in Step S9 is performed normally is verified.

The verification is performed, for example, by deriving a checksum value of data of the update buffer region B (75) and a checksum value of data written to the drive data storage area (71), and checking if these checksum values match.

Step S11: Determination of the result of the verification

As a result of the verification in Step S10, when the checksum values match, it is determined that the writing of the drive data has been performed normally, and the operation advances to Step S13. On the other hand, when the checksum values are different, it is determined that the writing is not normal, and the operation advances to Step S12.

Step S12: Halt Mode Processing

When the writing is not normal, halt mode processing is performed.

The processing from Step S8 to S11, for example, is repeated in order to attempt the downloading of the drive data again.

Alternatively, the download can be omitted, and the write processing in Step S9 to Step S11 can be performed again.

Further, when the checksum values do not match even after repeating any of a series of processing as described above, it is determined that the update processing is not possible. In this case, the determination can be outputted to the display unit that is not shown in the drawing, and the update processing can be terminated.

Step S13: Starting up the Display Driver 5

When the result of the verification in Step S11 is normal, the display controller 5 is activated. For example, the power supply to the display driver 5 that has been interrupted is resumed and a predetermined functional operation is started.

Then, it is confirmed that the starting up is normally performed and normal display processing is enabled. The confirmation of the normal operation is performed, for example, by detecting a current value of a sustain unit and determining whether or not the detected current value is normal.

Step S14: Determining a Normal Operation

When it is confirmed that the display driver 5 is normally operated, the update processing is terminated.

At this time, the data stored in the update buffer regions A and B is unnecessary and may be deleted, although the deletion is not essential.

On the other hand, when the operation of the display driver 5 is not normal, the operation advances to Step S15, and restoring mode processing is performed.

Here, the case in which the operation is not normal includes such cases as no image is displayed, a characteristic that should have been improved by the update is not improved, the current value of the sustain unit is abnormal.

In such cases, it is considered that the abnormality is caused by the update of the drive data, and therefore processing of restoring the drive data to that before the update is performed (restoring mode processing).

Step S15: Restoring Mode Processing

Here, the piece of drive data that has been temporarily evacuated to the update buffer region A (74) is read and overwritten to the storage area (71) for the drive data. That is, the drive data is rewritten by the original drive data before the update.

Then, it is confirmed whether or not the display processing is performed in the same manner before the update processing is performed. With this, the update processing is terminated. However, because this case means that the update failed or the operation is not performed as expected even if the update has been done, it is preferable that a notification that the update has not been normally performed is outputted to such as a display unit.

The above described is one embodiment of the update processing according to the present invention. However, the present invention is not limited to the series of processing as described above, and the processing of each step can be altered as needed, or other processing can be added.

Further, although the update buffer regions A and B can be provided separately in the storage unit 7, a volatile rewritable storage device such as a RAM or a reserved register can be used as the update buffer regions A and B as the data to be stored in these regions are stored only temporarily.

Further, the update processing is explained as started by a specific input operation made by such as the owner of the PDP apparatus 1. However, it is possible to provide a timer to automatically perform the update processing, rather than starting by the input operation. In this case, timing information relating to a time at which the update request of the drive data is transmitted to the server is stored in the storage unit.

Further, in order to perform the update processing on a regular basis, it is possible to specify time, day, month, and year, or a time interval, at which the update processing is performed on the PDP apparatus 1 side.

Moreover, rather than starting the update processing using the update request on the PDP apparatus 1 side as a trigger, the update processing can be performed by polling from the server 11 to a plurality of PDPs 1 after a new piece of drive data is stored in the server 11.

Further, the update of the drive data can also be performed by a user optionally selecting and downloading several pieces of drive data with various characteristics (such as high contrast) that are previously provided.

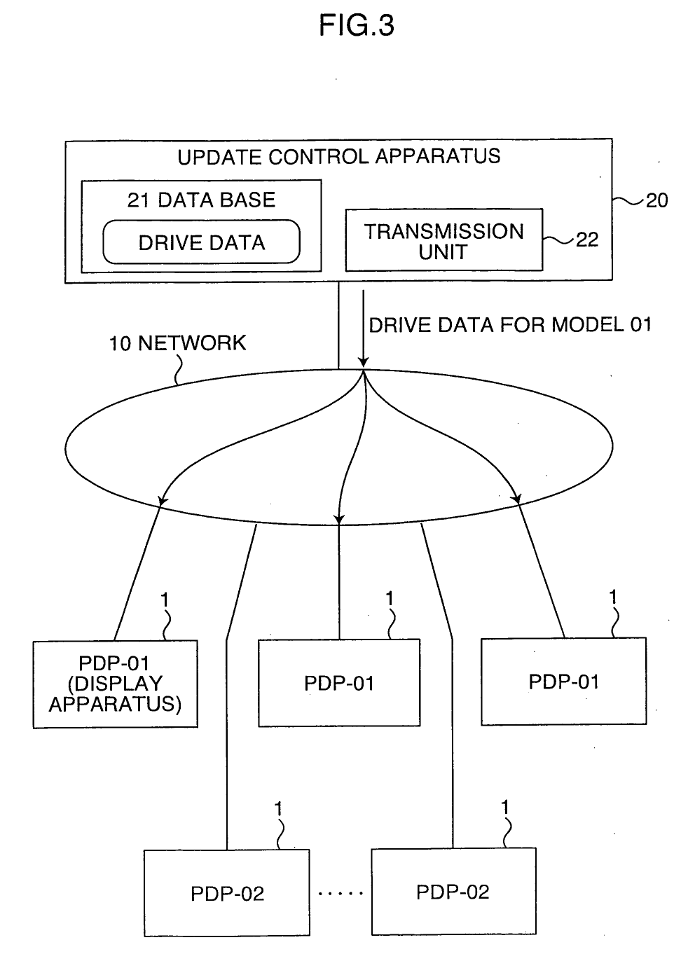

FIG. 3 shows a block diagram of another embodiment of the update processing according to the present invention.

Here, a configuration block diagram is shown in which a plurality of PDP apparatuses 1 and a single update control apparatus 20 are connected via the network 10.

Each PDP apparatus 1 has the same configuration as that shown in FIG. 1. The update control apparatus 20 is a terminal installed at a site in the manufacturer of the PDP apparatuses or a maintenance service provider of the PDP apparatuses. The update control apparatus 20 is provided with at least a database 21 containing history management information for specifying the PDP apparatus and drive data for the PDP apparatus, and a transmission unit 22 that sends the drive data to the PDP apparatus 1.

The update control apparatus 20 is, for example, a personal computer or a workstation provided with a high-capacity storage device such as a hard disk.

Further, the update control apparatus 20 has an access right for all of the PDP apparatuses 1 that are managed by the update control apparatus 20, and is provided with a function for accessing the PDP apparatuses that belong to a specific group and a function for requesting the update of the drive data to the PDP apparatuses that belong to a specific group.

Here, the PDP apparatuses that belong to a specific group are a plurality of PDP apparatuses that store the same drive data and display images according to the drive data, and, for example, the same model of PDP apparatuses. FIG. 3 shows a group of PDP apparatus having a model number 01 (PDP-01) and a group of PDP apparatus having a model number 02 (PDP-02).

As one example, it is assumed that the update control apparatus 20 newly stores a piece of drive data that is common to the PDP apparatuses of the model number (01). The update control apparatus 20 uses the history management information to extract the PDP apparatus (PDP-01) of the model 01 relating to the new drive data, and distributes the new piece of drive data to the extracted PDP apparatuses (PDP-01).

With this, it is possible to perform the update processing for all of the related PDP apparatus from the update control apparatus 20, without needing the user on a PDP apparatus side performs the update operation by own will, and without needing the serviceman visiting a site of the PDP apparatuses to perform the update operation.

Specifically, because it is possible to perform and control the update processing for all of the PDP apparatuses with a single update control apparatus 20, the update operation on the PDP apparatus side is unnecessary, and thus it is possible to reduce time and cost (personnel costs, cost for transport of apparatuses) for the update operation, preventing an error in update processing and wrong update processing-by a inexperienced user.

Specifically, a unique access key code is provided and stored for each serial number of each of the PDP apparatus 1, and the update control apparatus 20 stores the serial numbers and the access key codes for all of the PDP apparatus that are under control.

When the update control apparatus 20 performs the update processing to the PDP apparatus (PDP-01) of the model 01, first, a serial number is acquired from a connected PDP-01, and an access key code associated with the serial number is sent to the PDP apparatus 1. The PDP-01 receiving the access key code transmits information of update permission by the PDP-01 to the update control apparatus 20, when an access key code that has been previously stored in the storage unit 7 of the PDP-01 matches the received access key code.

The update control apparatus 20 sends a new piece of drive data to the PDP-01 after receiving the update permission information.

Then, after receiving the new piece of the drive data, the PDP-01 that has permitted the update updates the drive data by performing the same processing as in the steps following Step 6 shown in FIG. 2.

As described above, the update processing using the access key codes enables mass update of the drive data in a more secure and easier manner.

According to the present invention, the update processing of the drive data is facilitated, because the drive data relating to the display characteristics of the display apparatus such as the PDP apparatus is acquired from the server via the network to update.

Further, it is possible to update the drive data with a simple operation on the PDP apparatus side even by a user without technical knowledge on the PDP apparatuses, thereby preventing an error in operation.

Moreover, it is possible to simplify the operation and reduce the time and cost for the maintenance even when the serviceman performs the update operation on the PDP apparatus side.

Further, by providing the update control apparatus capable of connecting to each PDP apparatus via the network, it is possible to perform the update of a number of PDP apparatuses at the same time, thereby making the update operation on site where the PDP apparatus is installed unnecessary, and reducing the time for update operation and the maintenance cost.

1. A display apparatus comprising:
a display panel;
a communication controller for acquiring a piece of drive data related to the display panel from pieces of drive data stored in a server via a network;
a storage unit for storing the acquired piece of drive data and history management information for the display panel and the stored piece of drive data;
a display driver for displaying an image on the display panel according to the piece of drive data stored in the storage unit; and
a drive controller that has the communication controller acquire a piece of drive data for the display panel by using the history management information and updates a piece of drive data previously stored in the storage unit to the acquired piece of drive data.

2. The display apparatus according to claim 1, wherein
the drive data includes:
a value of a voltage to be applied to an electrode of a plasma display panel;
a timing at which the voltage is applied to the electrode and a pulse width of the applied voltage;
data defining an order of a plurality of sub-fields that constitute a single field as a unit of a display period for the plasma display panel; and
data defining a number of gray scale levels for the plasma display panel and a combination of sub-fields corresponding to the number of gray scale levels.

3. The display apparatus according to claim 1, wherein
the history management information includes a unique identification number for identifying the display apparatus, and a history number for a piece of drive data that is currently stored in the storage unit, and
the communication controller acquires a piece of drive data sent from the server after sending the history management information to the server.

4. The display apparatus according to claim 1, further comprising an input unit for instructing a request for updating the piece of drive data to the server, and
when the update request is inputted via the input unit, the communication controller sends the update request to the server and then receives a piece of drive data from the server.

5. The display apparatus according to claim 1, wherein
the storage unit stores timing information related to time at which sends a request for updating the drive data to the server, and
the communication controller sends the update request to the server according to the timing information.

6. A drive data communication system comprising:
a server; and
display apparatuses connected to the server via a network, wherein
the server is provided with a database storing a plurality of pieces of drive data respectively for the display apparatuses, and
each display apparatus is provided with a display panel, a communication controller that acquires a piece of drive data related to the display panel from the server, a storage unit that stores the piece of drive data and history management information for the display panel and the piece of drive data, a display driver that displays an image on the display panel according to the piece of drive data stored in the storage unit, and a drive controller that updates a piece of drive data previously stored in the storage unit to the piece of drive data acquired by the communication controller.

7. A drive data communication system comprising:
an update control apparatus; and
a plurality of display apparatuses connected to the update control apparatus via a network, wherein
the update control apparatus is provided with a database storing a plurality of pieces of drive data respectively for the display apparatuses, and a transmission unit that transmits a piece of drive data to a display apparatus that belongs to a specific group, and
each display apparatus is provided with a display panel, a communication controller that receives a piece of drive data related to the display panel from the update control apparatus, a storage unit that stores the piece of drive data and history management information specifying the display panel, a display driver that displays an image on the display panel according to the piece of drive data stored in the storage unit, and a drive controller that updates a piece of drive data previously stored in the storage unit to the piece of drive data received by the communication controller after confirming that the received piece of drive data is transmitted from the update control apparatus that is given an update permission.
